(19) United States
(12) Patent Application Publication
(10) Pub. No.: US 2008/0098858 A1
(43) Pub. Date: May 1, 2008

(54) Plumber's wrench

(76) Inventor: John Thomas, Lake Butler, FL (US)

Correspondence Address: JACOBSON HOLMAN PLLC, 400 SEVENTH STREET N.W., SUITE 600, WASHINGTON, DC, 20004, US

(21) Appl. No.: 11/896,387

(22) Filed: Aug. 31, 2007

Related U.S. Application Data
(60) Provisional application No. 60/855,399, filed on Oct. 31, 2006.

(51) Int. Cl. B25B 13/06

(52) U.S. Cl. 81/124.2

(57) ABSTRACT

A single tool easily secures a nut to anchor a sink in a fixed location and to connect two water lines to the faucet, all performed in a limited space. The use of a single elongated pipe having a plurality of grip bars projecting from an exterior surface assists in grabbing, holding and twisting of the pipe. The pipe has two integral sockets at opposite ends of the pipe.

This application is a complete application claiming the benefit of provisional application Ser. No. 60/855,399, filed Oct. 31, 2006.

### FIELD OF THE INVENTION

The present invention includes a tool to aid a plumber in working with faucet connections by the use of a set of sockets sized to fit the nuts generally associated with faucet and water line connection.

### BACKGROUND OF THE INVENTION

Installation of faucets, whether in a kitchen, bathroom, utility room or other location, usually involves the securing of the faucet at the rear of a sink rim or sink basin. With the faucet water connections being located below a counter top or sink level, the area within which the water connections are made is often limited and difficult to access.

Due to space constraints, it is difficult to provide the lateral swinging motion of a wrench required to initially anchor the faucet on a counter top or on top of a sink rim by securing a washer, usually plastic, around a threaded pipe of the faucet protruding through the counter top or sink lid.

After securing the washer and thereby the faucet in place, water connections are made by flexible water connection lines between a water shut off valve and the intake to the sink hot and cold water lines. All of these connections are usually made in limited sight areas and even more limited lateral wrench movement areas.

### SUMMARY OF THE INVENTION

Accordingly, it is an object of the present invention to easily secure a nut to anchor a sink in a fixed location and to connect two water lines to the faucet, all performed in a limited space with a single tool.

This object is accomplished by the present invention through the use of a single elongated pipe having a plurality of grip bars projecting from an exterior surface to assist in grabbing, holding and twisting of the pipe. The pipe has two integral sockets at opposite ends of the pipe.

One socket at one end of the pipe is hexagonal and the other socket at the other end of the pipe is round with twelve slots. The two sockets are formed at opposite ends of a single, unitary, approximately 1.75 inch outer diameter, PVC or ABS plastic pipe. The pipe is approximately 12 inches long.

The pipe allows passage through its hollow interior of a water supply line. Each of the ends of the pipe performs a different function for anchoring a faucet and connecting a water supply line. The pipe is reversible to take off or tighten a faucet connection and a water line connection.

The hexagonal socket includes an internal taper terminating in at least one stop pin to provide a tight fit on a hexagonal water line connecting nut. A stop ledge formed of the at least one stop pin prevents a nut from passing through the socket.

At the opposite end of the pipe, the equidistant twelve spaced slots accommodate projecting flanges of a plastic nut used to anchor the faucet to a support surface. The flanges of the nut are typically spaced at 30 degrees (12 flanges), 60 degrees (6 flanges), 90 degrees (4 flanges), 120 degrees (3 flanges), or 180 degrees (2 flanges).

Accordingly, for installation of a sink, the multi-slotted end of the tube is passed over a hand tightened water line to be extended between a shut off valve and the water inlet connection of a hot or cold water connection for the faucet. A nut surrounding the threaded inlet of the faucet has its flanges engage with the slots of the pipe and, by rotation of the pipe, the nut draws the escutcheon plate of the faucet onto either the rim of the sink or the counter top to which the faucet is to be secured. Continued rotation of the pipe secures the nut in tight contact with the under surface of the counter top onto which the sink is mounted.

The pipe is then retracted and reversed and threaded over the flexible water line to engage the nut that secures the water line to the hot or cold water inlets of the sink. The nut of the water line connection is received in the hexagonal shaped end of the pipe and prevented from passing through the hollow interior of the pipe by at least one stop pin. The pipe is then rotated to secure the connection of the water line to the inlet of the hot and cold water lines of the faucet. The pipe is then retracted over the water line and the free end of the flexible water line is connected to the hot or cold water supply line.

Accordingly, it is an object of the present invention to provide a single integral pipe having a socket at each of its two ends.

It is another object of the present invention to provide a single integral pipe having a socket at each of its two ends with one of the sockets including twelve slots for accommodating spaced flanges of a plastic nut at 30 degree, 60 degree, 90 degree, 120 degree or 180 degrees of separation.

It is still yet another object of the present invention to provide a single integral pipe having a socket at each of its two ends with one of the sockets including twelve slots for accommodating spaced flanges of a plastic nut at 30 degree, 60 degree, 90 degree, 120 degree or 180 degrees of separation with the opposite end of the pipe including a hexagonal shaped opening for engaging, but preventing from passing through, a nut connecting a flexible water line connection to a water line inlet of a sink.

It is still yet another object of the present invention to provide a single integral pipe having a socket at each of its two ends with one of the sockets including twelve slots for accommodating spaced flanges of a plastic nut at 30 degree, 60 degree, 90 degree, 120 degree or 180 degrees of separation with the opposite end of the pipe including a hexagonal fitting for engaging, but preventing from passing through, a nut connecting a flexible water line connection to a water line inlet of a sink with the exterior of the pipe including semi-circular grip bars for assisting in grabbing and rotating of the pipe.

These and other objects of the invention, as well as many of the intended advantages thereof, will become more readily apparent when reference is made to the following description taken in conjunction with the accompanying drawings.

### BRIEF DESCRIPTION OF THE DRAWINGS

The following drawings illustrate examples of various components of the plumber's wrench disclosed herein, and are for illustrative purposes only. Other embodiments that are substantially similar can use other components that have a different appearance.

FIG. 1 is a perspective view of the plumber's pipe wrench of the present invention.

FIG. 2 is a top view of the plumber's wrench.

FIG. 3 is a bottom view of the plumber's wrench.

FIG. 4 illustrates the use of two plumber's wrenches to secure a faucet to a rim of a sink with the left hand plumber's wrench engaging and tightening a nut on a threaded portion on the cold water inlet, and the right hand wrench securing a flexible water line to the water inlet of the hot water connection for the faucet.

FIG. 5 is a partial sectional view illustrating the engagement of the nut at the end of the flexible water line connection which is secured to a water inlet line of the faucet.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

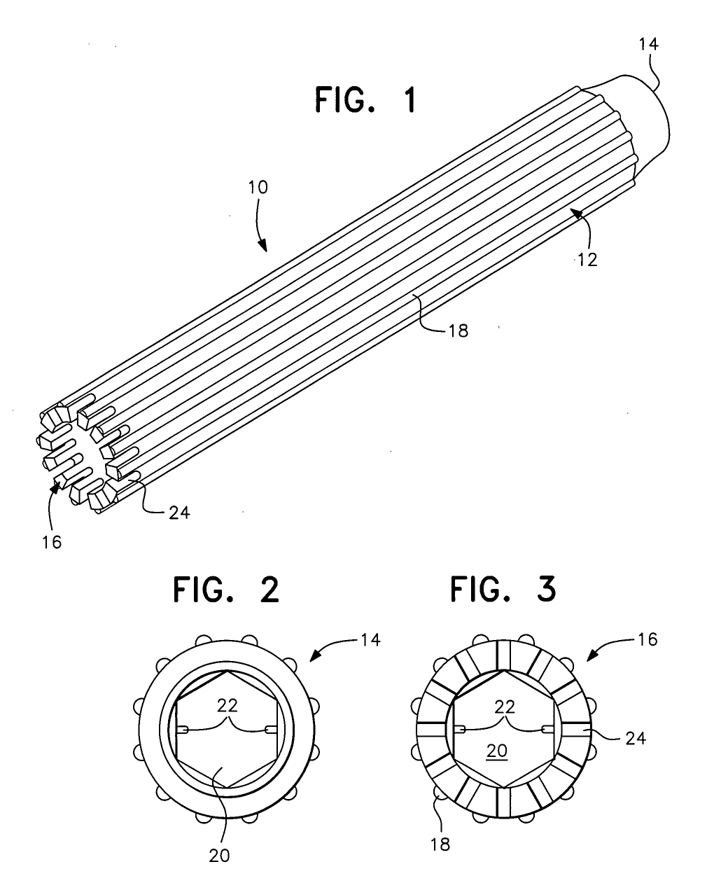

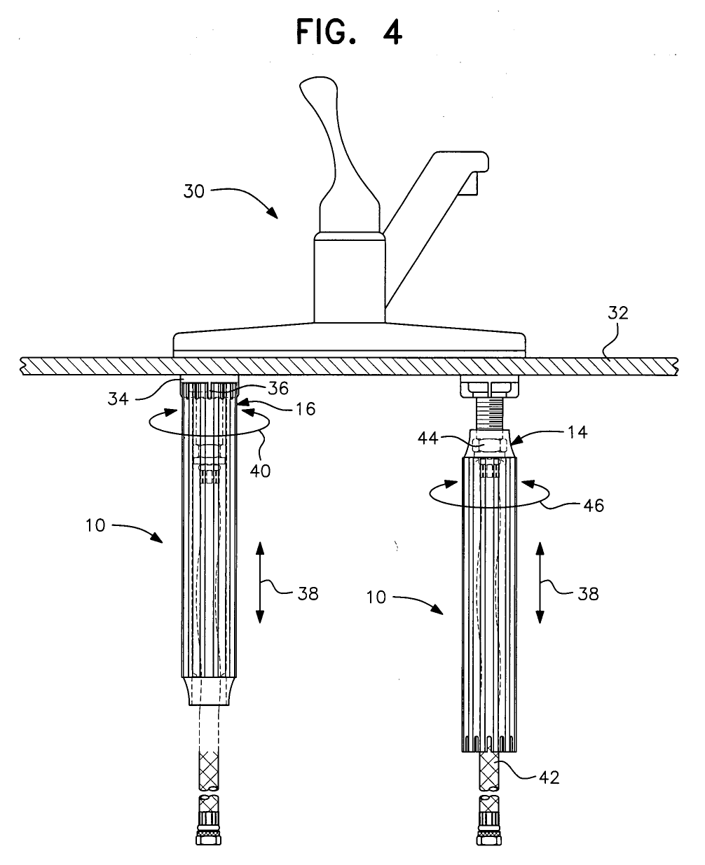

With reference to the drawings, in general, and FIGS. 1-3, in particular, a plumber's wrench embodying the teachings of the subject invention is generally designated as 10. With reference to its orientation of FIG. 1, the wrench includes a single unitary tube 12 made of PVC or ABS plastic.

The tube has an outside diameter of approximately 1.75 inches and an interior diameter of approximately 1.375 inches. The overall length of the pipe is approximately 12 inches.

The pipe has two opposite ends 14 and 16. Extending between the opposite ends are a plurality of equi-spaced semi-circular grip bars 18 extending from end 16 to within approximately one inch of end 14. The bars have a height of approximately 0.1 inches.

End 14 is tapered from a portion of the pipe including the bars 18 over approximately one inch of the terminal end of the pipe to decrease its outer diameter to approximately 1.3 inches. End 14 has an interior hexagonal shaped opening 20 with a separation distance between opposite faces of the hexagonal shaped opening 20 of approximately 0.906 inches.

Projecting radially inwardly from an interior surface of the pipe are two stop pins 22 which prevent passage through the interior of the pipe of a hexagonal shaped nut normally used to connect a flexible water line to a water inlet of a faucet. Alternatively, instead of two stop pins 22, a ledge extending radially inwardly from the interior of the pipe forms at least a portion of a circle to similarly engage a nut supported above the ledge for engagement with the side walls of the hexagonal shaped opening 20.

At opposite end 16, a plurality of slots 24 having a width of approximately 0.156 inches (approximately 5/32 inches) and a height of approximately ½ inch are cut from the pipe 12. The dimensioning of the slots is such as to engage the flanges of a nut used to secure a faucet to a support surface.

In FIG. 4, a faucet 30 is mounted on a counter top 32 by the use of the plumber's wrench of the present invention. In this Figure, two wrenches are shown as a demonstration of the functions that may be accomplished by a single plumber's wrench of the present invention, reversed for two different functions.

On the left hand side of FIG. 4, the plumber's wrench 10 is used with end 16 engaging a nut 34 by having its flanges 36 being engaged in the slots 24 formed at end 16. Movement of the wrench 10 in the direction of arrow 38 engages the flanges and by rotation of the pipe in the direction of arrow 40, tightens or loosens the nut 34 to draw the faucet into tight contact with the counter top.

On the right hand side of FIG. 4, the wrench 10 has been reversed so that end 14 has been passed over flexible water line connection 42. A nut 44 is engaged in end 14.

The flexible water line connection 42 passes through the hollow interior of the wrench 10 and between the stop pins 22 until the nut 44 is retained by the stop pins 22 for at least a loose fit of the sidewalls of the nut 44 with the sidewalls of the hexagonal opening 20 in end 14. Movement of the wrench in the direction of arrow 46 tightens or loosens the nut 44 on a water inlet to the faucet 30.

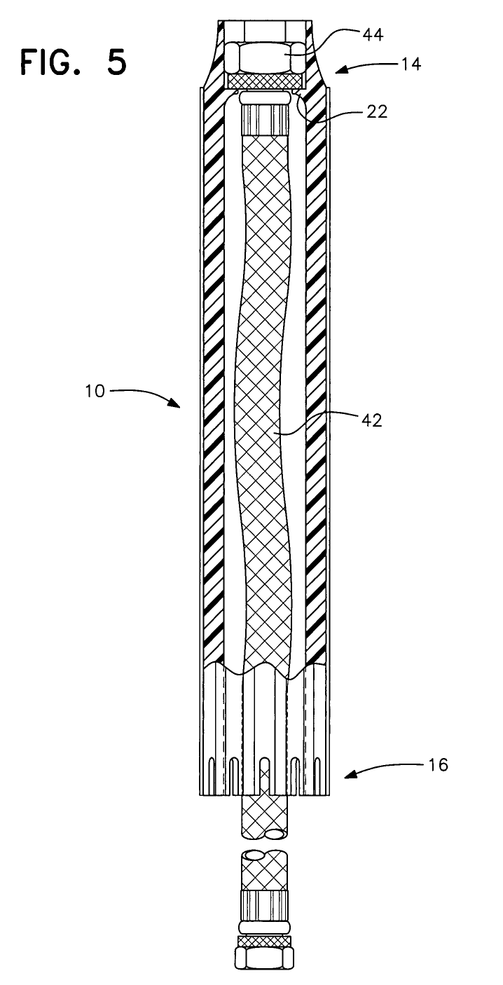

As shown in greater detail in FIG. 5, the nut 44 is shown engaged in the end 14 of the wrench 10 for engagement, holding and rotation with the wrench. The flexible water line 42 passes through the interior of the hollow wrench so as long as the nut 44 is initially threaded onto a water inlet line of the faucet, the wrench may be slid along the flexible water line 42 and into engagement with the nut 44 even without visual confirmation, for subsequent rotation of the wrench and tightening of the nut 44.

The foregoing description should be considered as illustrative only of the principles of the invention. Since numerous modifications and changes will readily occur to those skilled in the art, it is not desired to limit the invention to the exact construction and operation shown and described, and, accordingly, all suitable modifications and equivalents may be resorted to, falling within the scope of the invention.

I claim:

1. A plumber's wrench for connecting a faucet to a surface, said plumber's wrench comprising
an elongated tube having two ends, said elongated tube being hollow,
one of said two ends having a plurality of slots, and
the other of said two ends including a hexagonal shaped recess.

2. The wrench as claimed in claim 1, wherein said one end includes twelve slots.

3. The wrench as claimed in claim 2, wherein said slots are spaced equidistant.

4. The wrench as claimed in claim 1, wherein an exterior surface of said tube includes a plurality of grip bars.

5. The wrench as claimed in claim 4, wherein said grip bars are semicircular.

6. The wrench as claimed in claim 1, wherein said other end includes at least one stop pin projecting radially inwardly.

7. The wrench as claimed in claim 6, wherein there are two stop pins.

8. The wrench as claimed in claim 7, wherein a radially innermost end of said two stop pins are separated by a distance of approximately 0.7 inches.

9. The wrench as claimed in claim 3, wherein said slots are approximately ⅛ inch wide.

10. The wrench as claimed in claim 9, wherein said slots are approximately 0.5 inches long.

11. A plumber's wrench for connecting a faucet to a surface, said plumber's wrench comprising
an elongated tube having two ends, said elongated tube being hollow,
one of said two ends having a plurality of slots, and
the other of said two ends including a hexagonal shaped recess, said hexagonal shaped recess having a width of approximately 0.9 inches.

12. The wrench as claimed in claim 11, wherein said one end includes twelve slots.

13. The wrench as claimed in claim 12, wherein said slots are spaced equidistant.

14. The wrench as claimed in claim 11, wherein an exterior surface of said tube includes a plurality of grip bars.

15. The wrench as claimed in claim 14, wherein said grip bars are semicircular.

16. The wrench as claimed in claim 11, wherein said other end includes at least one stop pin projecting radially inwardly.

17. The wrench as claimed in claim 16, wherein there are two stop pins.

18. The wrench as claimed in claim 17, wherein a radially innermost end of said two stop pins are separated by a distance of approximately 0.7 inches.

19. The wrench as claimed in claim 13, wherein said slots are approximately ⅛ inch wide.

20. The wrench as claimed in claim 19, wherein said slots are approximately 0.5 inches long.
